(19) United States
(12) Patent Application Publication
(10) Pub. No.: US 2014/0170628 A1
(43) Pub. Date: Jun. 19, 2014

(54) SYSTEM AND METHOD FOR DETECTING MULTIPLE-INTELLIGENCE USING INFORMATION TECHNOLOGY

(71) Applicant: Electronics and Telecommunications Research Institute, Daejeon (KR)

(72) Inventors: Chan Kyu PARK, Daejeon (KR); Woo han YUN, Daejeon (KR); Do-Hyung KIM, Daejeon (KR); Ho Sub YOON, Daejeon (KR); Jae Hong KIM, Daejeon (KR)

(21) Appl. No.: 13/929,741

(22) Filed: Jun. 27, 2013

(30) Foreign Application Priority Data
Dec. 13, 2012 (KR) 10-2012-0145578

(51) Int. Cl. G09B 7/06

(52) U.S. Cl. CPC G09B 7/06
USPC 434/362

(57) ABSTRACT

Provided is a multiple-intelligence detection system. The multiple-intelligence detection system includes an image detection device obtaining image information for evaluating multiple-intelligence from a user, a multiple-intelligence measurement model unit receiving the image information from the image detection device to perform multiple-intelligence evaluation through selection of one of a first reaction and a second reaction, and a content unit receiving a result of the evaluated multiple-intelligence from the multiple-intelligence measurement model unit to generate an individual portfolio on the basis of the received result. The multiple-intelligence measurement model unit selects one of the first and second reactions on the basis of a reference reaction according to feelings and behavior patterns of the user.

### CROSS-REFERENCE TO RELATED APPLICATIONS

This U.S. non-provisional patent application claims priority under 35 U.S.C. §119 of Korean Patent Application No. 10-2012-0145578, filed on Dec. 13, 2012, the entire contents of which are hereby incorporated by reference.

### BACKGROUND OF THE INVENTION

The present invention disclosed herein relates to a system for detecting multiple-intelligence, and more particularly, to a system for detecting multiple-intelligence of a user by using information technologies (ITs).

In general, intelligence quotient (IQ) detection methods have been representatively used as methods for detecting user's intelligence. IQ scores show degrees of intellectual development as numerical values. The IQ scores are detected through a series of tests such as a calculating test, a vocabulary test, and the like. Also, IQ detection methods show where a relative level of user's intelligence corresponds to a predetermined group of the whole groups on the basis of an IQ test score of the user.

However, such an IQ detection method has a limitation in that it is difficult to accurately grasp intelligence or talent that is embedded in a user. Thus, to grasp various talents and characteristics of the user, a multiple-intelligence detection method in which IQ of the human is divided into eight domains to perform detection for each domain has been introduced by James Gadner.

Particularly, an individual portfolio on the basis of the multiple-intelligence measurement method is being increased in use. Whether the user does well or not well for each domain is evaluated through the portfolio on the basis of the multiple-intelligence with respect to the eight domains of the human. Thus, the user may more easily check user own characteristics and talents with reference to a user own portfolio.

Also, the user performs contents with respect to the multiple-intelligence for each domain or consults with experts to perform the multiple-intelligence detection. However, to grasp the user's multiple-intelligence for each domain, a large number of experts and a large amount of time and cost are needed.

### SUMMARY OF THE INVENTION

The present invention provides a multiple-intelligence detection system in which user's multiple-intelligence is detected through a camera sensing-based device to analyze the detected user's multiple-intelligence through information technologies (ITs), but not through an expert.

The feature of the present invention is not limited to the aforesaid, but other features not described herein will be clearly understood by those skilled in the art from descriptions below.

Embodiments of the present invention provides multiple-intelligence detection systems including: an image detection device obtaining image information for evaluating multiple-intelligence from a user; a multiple-intelligence measurement model unit receiving the image information from the image detection device to perform multiple-intelligence evaluation through selection of one of a first reaction and a second reaction; and a content unit receiving a result of the evaluated multiple-intelligence from the multiple-intelligence measurement model unit to generate an individual portfolio on the basis of the received result, wherein the multiple-intelligence measurement model unit selects one of the first and second reactions on the basis of a reference reaction according to feelings and behavior patterns of the user.

In some embodiments, one of the first and second reactions may be selected through a likes and dislikes method.

In other embodiments, the multiple-intelligence measurement model unit may include user profile in which the reference reaction of the user is stored.

In still other embodiments, the multiple-intelligence detection systems may further include a user management unit for providing a user service to the individual portfolio.

In even other embodiments, the individual portfolio may be confirmed through an electronic device such as a smart phone or a table PC of the user.

In yet other embodiments, the user management unit may be manufactured in a form of a server.

In further embodiments, the image detection device may include various contents related to the multiple-intelligence.

In still further embodiments, the contents may be decided in consideration of age and gender of the user.

Embodiments of the present invention provide methods for detecting multiple-intelligence of a user, the method including: measuring image information through the user; performing multiple-intelligence evaluation through selection of one of a first reaction and a second reaction with respect to the measured image information; and generating an individual portfolio on the basis of the evaluated multiple image information, wherein the multiple-intelligence evaluation is performed to decide one of the first and second reactions on the basis of a reference reaction according to feelings and behavior patterns of the user.

In some embodiments, in the performing of the multiple-intelligence evaluation, one of the first and second reactions may be selected through a likes and dislikes method.

In other embodiments, the measuring of the image information may be performed through an interaction between the user and contents related to the multiple-intelligence.

In still other embodiments, the generated individual portfolio may be stored through a server.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram of a multiple-intelligence detection system according to an embodiment of the present invention;

FIG. 2 is a block diagram of an image detection device according to an embodiment of the present invention;

FIG. 3 is a photograph illustrating one realization example of the image detection device of FIG. 1;

FIG. 4 is a photograph illustrating the other realization example of the image detection device of FIG. 1;

FIG. 5 is a block diagram illustrating a multiple-intelligence measurement model unit of FIG. 1; and

FIG. 6 is a flowchart illustrating an operation process of the multiple-intelligence detection system according to an embodiment of the present invention.

### DETAILED DESCRIPTION OF PREFERRED EMBODIMENTS

Preferred embodiments of the present invention will be described below in more detail with reference to the accompanying drawings, such that those skilled in the art can realizes the technical ideas of the inventive concept without difficulties. Like reference numerals refer to like elements throughout. Similar reference numerals refer to similar elements throughout. A multiple-intelligence system to be described below and an operation performed by the same are merely an example, and thus various modifications and variations can be made in the present invention without departing form the spirit or scope of the invention.

The multiple-intelligence detection that is introduced in recent years has been developed based on that it is difficult to determine talents and capability of the human by using only an intelligence quotient (IQ) test. According to the multiple-intelligence detection method, user's intelligence is detected for each domain with respect to eight domains such as linguistic, musical, logical-mathematical, visual-spatial, bodily-kinesthetic, interpersonal, intrapersonal, and naturalist domains. Also, according to the multiple-intelligence detection method, the overall talents and capability of a user are determined by combining intelligence corresponding to the respective domains.

However, to detect the user's intelligence for each domain, a large number of experts and a large amount of time are needed. Thus, a multiple-intelligence detection method that is capable of reducing the detection time and costs is required.

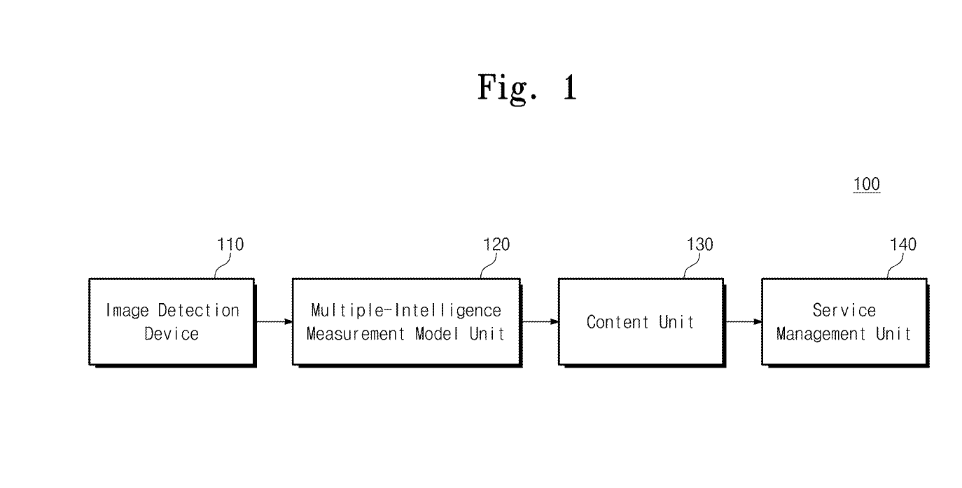

FIG. 1 is a block diagram of a multiple-intelligence detection system according to an embodiment of the present invention.

Referring to FIG. 1, a multiple-intelligence detection system 100 includes an image detection device 110, a multiple-intelligence measurement model unit 120, a content unit 130, and a service management unit 140.

The image detection device 110 measures image information required for detecting multiple-intelligence of a user. An existing method for measuring multiple-intelligence of a user is performed through a test using questionnaires or direct counsel with an expert. However, according to the test using questionnaires, user's interests or concentration may be reduced, and thus it may be difficult to obtain accurate result values. Also, the method performed through the counsel with the expert takes a large amount of time to detect the multiple-intelligence.

On the other hand, the image detection device 110 may be manufactured as an electronic device including a camera or a sensor to photograph image, sound, and bio signals. Also, the image detection device 110 may measure image information through an interaction with the user. For example, when the user reacts to contents provided through a smart device, the image detection device 110 may measure image information on the basis of the reaction of the user. The image information may include contents with respect to user's feelings or behavior patterns occurring while performing the contents.

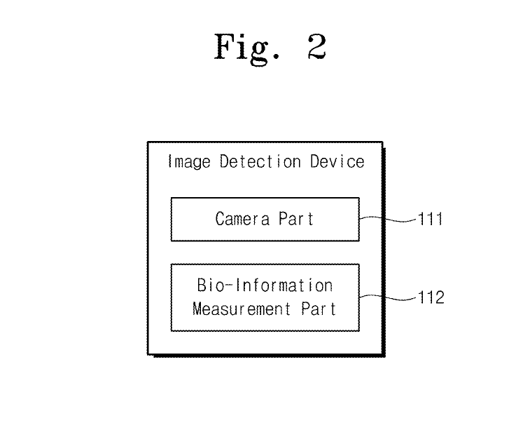

Also, the image detection device 110 may include the eight contents for grasping the intelligence for the eight domains from the user. The contents may be manufactured with various contents on the basis of age or gender of the user. The image information measured for each domain is transmitted into a multiple-intelligence measurement model unit 120 through the image detection device 110. The image detection device 110 will be described in detail with reference to FIG. 2.

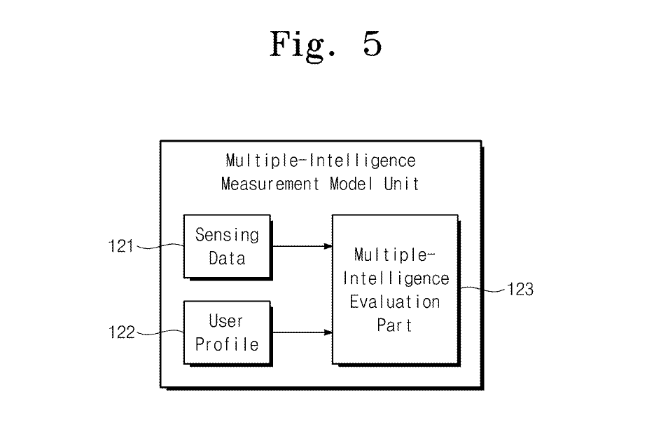

The multiple-intelligence measurement model unit 120 receives the user's image information measured for each domain through the image detection device 110. Also, the multiple-intelligence measurement model unit 120 performs an analysis process for determining the user's intelligence with respect to the received image information for each domain. Particularly, the multiple-intelligence measurement model unit 120 determines the user's intelligence through the analysis process using a likes and dislikes method with respect to the received image information for each domain. The analysis process using the likes and dislikes method will be described in detail with reference to FIG. 5. Also, the multiple-intelligence measurement model unit 120 transmits the analyzed results for each domain into the content unit 130.

The content unit 130 receives user's intelligence information analyzed for each domain through the multiple-intelligence measurement model unit 120. The content unit 130 generates an individual portfolio on the basis of the intelligence information analyzed for each domain. The portfolio may have a reference form for grasping whether the user does well or not well with respect to intelligence for each user own domain. Thus, the portfolio may be used for coming up with future careers and lift plans of the user.

Also, the content unit 130 may generate program adequate for user's aptitude on the basis of the determination of the intelligence for each domain. For example, the content unit 130 may provide program that gives talents related to the interpersonal domain when the interpersonal domain in which personal relations are superior among the domains for determining the user's intelligence for each domain is determined as an advantage.

The user may grasp one's well-done or not well-done by using the individual portfolio to previously grasp things that can be well-done by the user, i.e., talents. Also, the content unit 130 transmits the generated individual portfolio into the service management unit 140.

The service management unit 140 is manufactured in a form of a server to receive and store the individual portfolio generated through the content unit 130. Also, the user may confirm the user own portfolio anytime by using radio communication between an own smart device and the service management unit 140. Also, in a case where the user is a child, a teacher or parent may continuously grasp intelligence information of the child with reference to the child's portfolio stored in the service management unit 140. As a result, the teacher or parent may detect the child's aptitudes and talents in early stage to provide educational environments adapted for the child's aptitudes and talents.

As described above, the multiple-intelligence detection system 100 may detect the user's intelligence through the multiple intelligence detection method in which information technologies (ITs) are realized. Also, the multiple-intelligence detection system 100 may perform the multiple-intelligence detection by using various contents to improve user's interests and concentrations. Thus, the multiple-intelligence detection system 100 may reduce the detection time and cost when compared to those in an existing multiple-intelligence detection method.

FIG. 2 is a block diagram of an image detection device according to an embodiment of the present invention. Referring to FIG. 2, an image detection device 110 includes a camera unit 111 and a bio-information measurement unit 112. The image detection device 110 may be provided in a smart device or the surroundings of the user to measure image information for each domain by the user.

The camera unit 111 may be realized by a camera-based electronic device that is capable of photographing an image and sound. The camera unit 111 may photograph a sound and image of the user that performs the multiple-intelligence detection with respect to each domain through the content contents. Also, the camera unit 111 photographs everyday life of the user to transmit the photographed information to the multiple-intelligence measurement model unit 120 (see FIG. 1). Thus, the multiple-intelligence measurement model unit 120 may grasp a user's behavior pattern on the basis of the information in which the everyday life of the user is photographed.

The bio-information measurement unit 112 detects bio-information from the user by using a plurality of sensors. For example, when the user responds to the content contents to touch the smart device, the bio-information measurement unit 112 may measure intensity of a pressure and a temperature according to the touch operation to detect the reaction of the user.

Particularly, the image detection device 110 may measure a multiply-intelligence quotient of the user by using various kinds of contents based on age, gender, and personality of the user. For example, when the multiple-intelligence of the child is detected, the image detection device 110 may perform the multiple-intelligence detection of the child by using contents such as cartoons. Thus, since the multiple-intelligence detection is performed by using the contents such as the cartoons that is a favorite of children, interests and concentration of the children may be improved.

Also, the image detection device 110 may be provided in various kinds of electronic devices such as the smart device to perform the multiple-intelligence detection of the user.

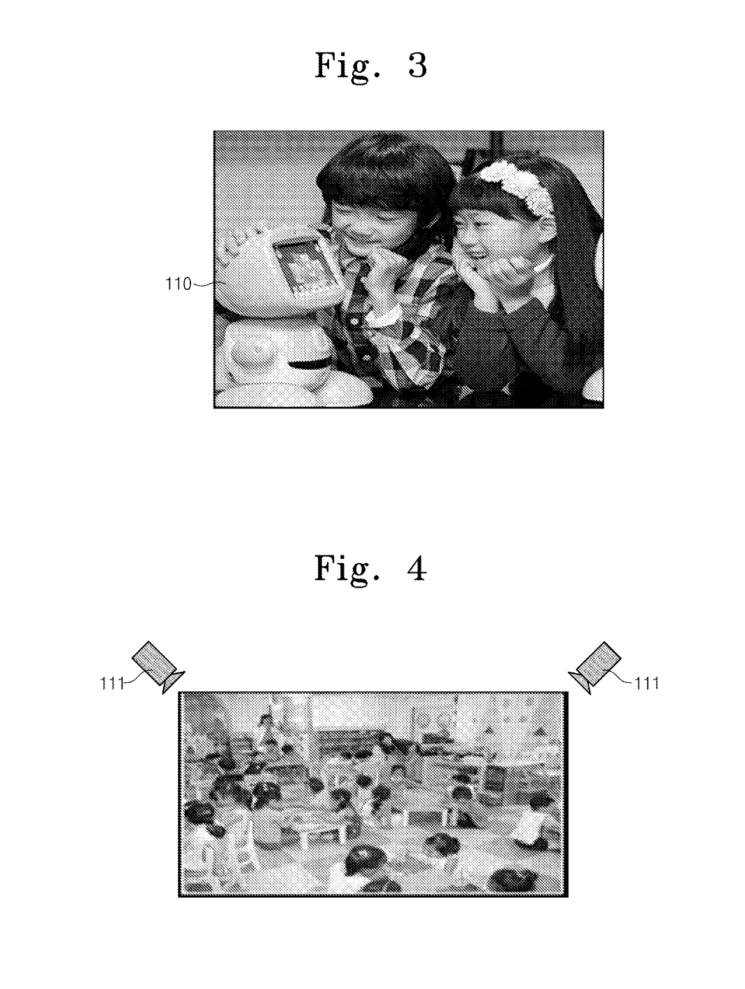

FIG. 3 is a photograph illustrating one realization example of the image detection device of FIG. 4. Referring to FIG. 3, the image detection device 110 (see FIG. 1) is realized in a form of a robot. As described above, since the content contents for detecting the multiple-intelligence are provided as the robot that is a favorite of children, the multiple-intelligence may be smoothly detected through an interaction between the children and the robot.

FIG. 4 illustrates a state in which the camera unit 111 is provided in the surrounding environments of the user. Referring to FIG. 4, the camera unit 111 may be provided in education environments of the children to smoothly photograph everyday life of the children. The multiple-intelligence measurement model unit 120 may grasp a child's behavior pattern on the basis of the information photographed through the camera unit 11.

As described above, the image detection device 110 may be realized as various electronic devices to measure the image information of the user through an interaction with the user.

FIG. 5 is a block diagram illustrating the multiple-intelligence measurement model unit of FIG. 1. Referring to FIG. 5, the multiple-intelligence measurement model unit 120 includes a sensing data part, a user profile 122, and a multiple-intelligence evaporation part 123.

The sensing data part 121 receives and stores user's image information measured for each domain through the image detection device 110 (see FIG. 1). Also, the sensing data part 121 transmits the stored image information to the multiple-intelligence evaporation part 123.

The user profile 122 stores user's reference reaction information for evaporating the user's image information for each domain stored in the sensing data part 121. Here, the reference reaction information may function as a reference value with respect to a level of good or bed of user's feelings and behavior patterns on the basis of user's expression, behavior, voice tone, hart rate, and the like. That is to say, the user's image information stored in the sensing data part 121 may be evaporated on the basis of the user profile 122. The user profile 122 may store the user's reaction information through teachers, parents, and surrounding acquaintances.

The multiple-intelligence evaporation part 123 receives the user's image information from the sensing data part 121 and the user's reference reaction information from the user profile 122. The multiple-intelligence evaporation part 123 determines user's intelligence for each domain on the basis of the received user's image information and reference reaction information.

The multiple-intelligence evaporation part 123 uses the likes and dislikes method as a method for determining the intelligence for each domain. The likes and dislikes method is a method for determining whether the intelligence performance for each domain is well-done or not on the basis of the user's reference reaction information. For example, the multiple-intelligence evaporation part 123 compares the image information measured through the image detection device 110 with respect to the user's visual-spatial domain to the user's reference reaction information. Then, the multiple-intelligence evaporation part 123 determines whether the intelligence performance for each domain is well-done or not by the user on the basis of the compared result.

As described above, the multiple-intelligence evaporation part 123 determines the user's intelligence for each domain on the basis of the user profile 122 and transmits the determined result to the content unit 130 (see FIG. 1). Also, since an existing analysis process for detecting the multiple-intelligence is directly performed through the expert, it may take a long time to perform the analysis process. On the other hand, the multiple-intelligence measurement model unit 120 may perform the multiple-intelligence detection by using the electronic device such as computers to reduce the detection time.

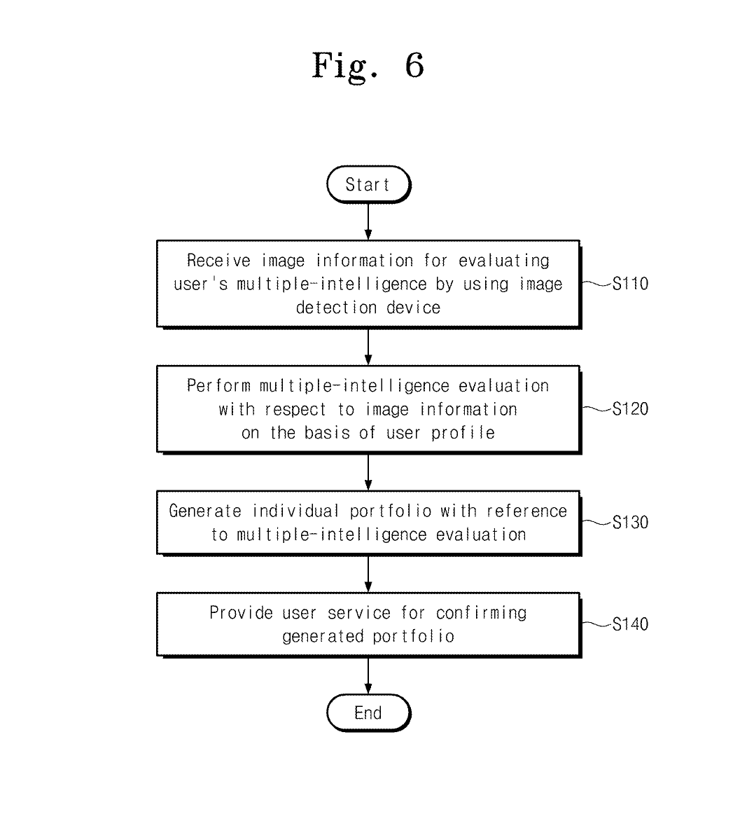

FIG. 6 is a flowchart illustrating an operation process of the multiple-intelligence detection system according to an embodiment of the present invention. Referring to FIG. 6, in operation 5110, a user performs a content for grasping an image information for each domain through an interaction with an image detection device 110 (see FIG. 1). The image information may store information with respect to user's feelings or behavior patterns occurring while performing the content.

Also, the content may be decided in consideration of characteristics of the user. That is to say, the content to be performed by the user may be decided with reference to factors such as age and gender of the user. Also, the image detection device 110 receives user's image information performed in the content for each domain to transmit the received image information to a multiple-intelligence measurement model unit 120.

In operation S120, the multiple-intelligence measurement model unit 120 (see FIG. 5) performs multiple-intelligence evaporation through a likes and dislikes method with respect to the image information for each domain on the basis of a user profile 122. Also, the user profile 122 stores reference information with respect to user's usual feelings and behavior states. For example, the user profile 122 stores reaction information that functions as a reference value through which a voice tone when the user is feeling happy and a voice tone when the user is felling unhappy can be divided. The multiple-intelligence measurement model unit 120 may perform the multiple-intelligence evaporation through the likes and dislikes method with respect to the image information measured for each domain on the basis of the user's reaction information.

In operation 5130, the content unit 130 receives multiple-intelligence evaporation results with respect to the user's intelligence information for each domain. Also, the content unit 130 generates a user portfolio with reference to the received user's multiple-intelligence evaporation results. The contents of the portfolio may be expressed as the likes and dislikes method such as the well-done or not well-done with respect to the user's intelligence information for each domain. On the basis of the above-described contents, the user may determine his interesting fields and the things he is good at. Also, the portfolio is stored in a storage medium such as a server.

In operation 5140, the user may continuously confirm the his own portfolio stored in the server by using a smart device. If the user is an infant or child, the teacher or parent may continuously refer to the infant's or child's portfolio to manage talents or personality of the infant or child.

As described above, the multiple-intelligence detection system 100 may replaces the intelligence detection performed through the expert with the ITs to reduce the detection time and cost. Also, the multiple-intelligence detection system 100 in which the ITs are realized may be used to continuously manage the child's talents and qualification by the teacher or parents.

According to the embodiment of the present invention, the multiple-intelligence detection system may analyze the user's multiple-intelligence by using the ITs to reduce the detection cost and time.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multiple-intelligence detection system comprising:
an image detection device obtaining image information for evaluating multiple-intelligence from a user;
a multiple-intelligence measurement model unit receiving the image information from the image detection device to perform multiple-intelligence evaluation through selection of one of a first reaction and a second reaction; and
a content unit receiving a result of the evaluated multiple-intelligence from the multiple-intelligence measurement model unit to generate an individual portfolio on the basis of the received result,
wherein the multiple-intelligence measurement model unit selects one of the first and second reactions on the basis of a reference reaction according to feelings and behavior patterns of the user.

2. The multiple-intelligence detection system of claim 1, wherein one of the first and second reactions is selected through a likes and dislikes method.

3. The multiple-intelligence detection system of claim 1, wherein the multiple-intelligence measurement model unit comprises user profile in which the reference reaction of the user is stored.

4. The multiple-intelligence detection system of claim 1, further comprising a user management unit for providing a user service to the individual portfolio.

5. The multiple-intelligence detection system of claim 4, wherein the individual portfolio is confirmed through an electronic device such as a smart phone or a table PC of the user.

6. The multiple-intelligence detection system of claim 4, wherein the user management unit is manufactured in a form of a server.

7. The multiple-intelligence detection system of claim 1, wherein the image detection device comprises various contents related to the multiple-intelligence.

8. The multiple-intelligence detection system of claim 7, wherein the contents are decided in consideration of age and gender of the user.

9. A method for detecting multiple-intelligence of a user, the method comprising:
measuring image information through the user;
performing multiple-intelligence evaluation through selection of one of a first reaction and a second reaction with respect to the measured image information; and
generating an individual portfolio on the basis of the evaluated multiple image information,
wherein the multiple-intelligence evaluation is performed to decide one of the first and second reactions on the basis of a reference reaction according to feelings and behavior patterns of the user.

10. The method of claim 9, wherein, in the performing of the multiple-intelligence evaluation, one of the first and second reactions is selected through a likes and dislikes method.

11. The method of claim 9, wherein the measuring of the image information is performed through an interaction between the user and contents related to the multiple-intelligence.

12. The method of claim 9, wherein the generated individual portfolio is stored through a server.
